(19) United States
(12) Patent Application Publication
(10) Pub. No.: US 2024/0095594 A1
(43) Pub. Date: Mar. 21, 2024

(54) LEVERAGING INTERMEDIATE CHECKPOINTS TO IMPROVE THE PERFORMANCE OF TRAINED DIFFERENTIALLY PRIVATE MODELS

(71) Applicant: Google LLC, Mountain View, CA (US)

(72) Inventors: Om Dipakbhai Thakkar, Fremont, CA (US); Arun Ganesh, Seattle, WA (US); Virat Vishnu Shejwalkar, Amherst, MA (US); Abhradeep Guha Thakurta, Los Gatos, CA (US); Rajiv Mathews, Sunnyvale, CA (US)

(73) Assignee: Google LLC, Mountain View, CA (US)

(21) Appl. No.: 18/459,354

(22) Filed: Aug. 31, 2023

Related U.S. Application Data
(60) Provisional application No. 63/376,528, filed on Sep. 21, 2022.

(51) Int. Cl. G06N 20/00

(52) U.S. Cl. CPC G06N 20/00

(57) ABSTRACT

A method includes training a first differentially private (DP) model using a private training set, the private training set including a plurality of training samples, the first DP model satisfying a differential privacy budget, the differential privacy budget defining an amount of information about individual training samples of the private training set that may be revealed by the first DP model. The method also includes, while training the first DP model, generating a plurality of intermediate checkpoints, each intermediate checkpoint of the plurality of intermediate checkpoints representing a different intermediate state of the first DP model, each of the intermediate checkpoints satisfying the same differential privacy budget. The method further includes determining an aggregate of the first DP model and the plurality of intermediate checkpoints, and determining, using the aggregate, a second DP model, the second DP model satisfying the same differential privacy budget.

### CROSS-REFERENCE TO RELATED APPLICATIONS

This U.S. Patent Application claims priority under 35 U.S.C. § 119(e) to U.S. Provisional Application 63/376,528, filed on Sep. 21, 2022. The disclosure of this prior application is considered part of the disclosure of this application and is hereby incorporated by reference in its entirety.

### TECHNICAL FIELD

This disclosure relates to leveraging intermediate checkpoints to improve the performance of trained differentially private (DP) models.

### BACKGROUND

Differentially private (DP) machine learning is commonly used for training private models on private data. A trained DP model is trained to not reveal sensitive information from the private data used to train the DP model. Differentially private stochastic gradient descent (DP-SGD) has become a de facto standard algorithm for centralized training of DP models.

### SUMMARY

One aspect of the disclosure provides a method for leveraging intermediate checkpoints to improve the performance of trained differentially private (DP) models. The method includes training a first differentially private (DP) model using a private training set. Here, the private training set includes a plurality of training samples, the first DP model satisfies a differential privacy budget, and the differential privacy budget defines an amount of information about individual training samples of the private training set that may be revealed by the first DP model. While training the first DP model, the method includes generating a plurality of intermediate checkpoints. Here, each intermediate checkpoint of the plurality of intermediate checkpoints represents a different intermediate state of the first DP model, and each of the intermediate checkpoints satisfies the same differential privacy budget. The method further includes determining an aggregate of the first DP model and the plurality of intermediate checkpoints, and determining, using the aggregate, a second DP model, the second DP model satisfying the same differential privacy budget.

Implementations of this aspect of the disclosure may include one or more of the following optional features. In some implementations, determining the aggregate of the first DP model and the plurality of intermediate checkpoints includes determining aggregate parameter values based on parameter values of the first DP model and parameter values of the plurality of intermediate checkpoints, and determining, using the aggregate, the second DP model includes using the aggregate parameter values as parameter values of the second DP model. In some examples, determining the aggregate parameter values includes determining a weighted sum of the parameter values of the first DP model and the parameter values of the plurality of intermediate checkpoints.

In some examples, determining the aggregate parameter values includes selecting a subset of intermediate checkpoints from the plurality of intermediate checkpoints, and averaging the parameter values of the first DP model and the parameter values of the subset of intermediate checkpoints. In some implementations, the subset of intermediate checkpoints includes a threshold number of latest intermediate checkpoints. In some examples, selecting the subset of intermediate checkpoints from the plurality of intermediate checkpoints includes determining, for each respective intermediate checkpoint of the plurality of intermediate checkpoints, a respective quality factor, and selecting each intermediate checkpoint of the subset of intermediate checkpoints based on the respective quality factor.

In some implementations, determining the aggregate of the first DP model and the plurality of intermediate checkpoints includes determining a combination of the first DP model and the plurality of intermediate checkpoints, and the second DP model includes the determined combination. In some examples, determining the aggregate of the first DP model and the plurality of intermediate checkpoints includes selecting a subset of intermediate checkpoints from the plurality of intermediate checkpoints, and determining the combination to include the first DP model and the selected subset of the intermediate checkpoints. In some implementations, the subset of intermediate checkpoints includes a threshold number of latest intermediate checkpoints. Optionally, selecting the subset of intermediate checkpoints from the plurality of intermediate checkpoints includes determining, for each respective intermediate checkpoint of the plurality of intermediate checkpoints, a respective quality factor, and selecting each intermediate checkpoint of the subset of intermediate checkpoints based on the respective quality factor.

In some examples, the method also includes determining outputs of the first DP model, determining a plurality of outputs for respective ones of the plurality of intermediate checkpoints, and determining outputs of the second DP model including an aggregate of the outputs of the first DP model and the plurality of outputs for respective ones of the plurality of intermediate checkpoints. In some implementation, the aggregate of the outputs of the first DP model and the plurality of outputs for respective ones of the plurality of intermediate checkpoints includes a majority vote based on the outputs of the first DP model and the plurality of outputs for respective ones of the plurality of intermediate checkpoints. In other implementations, the aggregate of the outputs of the first DP model and the plurality of outputs for respective ones of the plurality of intermediate checkpoints includes an average of the outputs of the first DP model and the plurality of outputs for respective ones of the plurality of intermediate checkpoints. The method may include predicting, using the second DP model, an output, and determining, using at least one of the plurality of intermediate checkpoints, an uncertainty of the predicted output.

Another aspect of the disclosure provides a system for leveraging intermediate checkpoints to improve the performance of trained differentially private (DP) models. The system includes data processing hardware and memory hardware in communication with the data processing hardware. The memory hardware stores instructions that when executed on the data processing hardware cause the data processing hardware to perform operations. The operations include training a first differentially private (DP) model using a private training set. Here, the private training set includes a plurality of training samples, the first DP model satisfies a differential privacy budget, and the differential privacy budget defines an amount of information about individual training samples of the private training set that may be revealed by the first DP model. While training the first DP model, the operations include generating a plurality of intermediate checkpoints. Here, each intermediate checkpoint of the plurality of intermediate checkpoints represents a different intermediate state of the first DP model, and each of the intermediate checkpoints satisfies the same differential privacy budget. The operations further include determining an aggregate of the first DP model and the plurality of intermediate checkpoints, and determining, using the aggregate, a second DP model, the second DP model satisfying the same differential privacy budget.

Implementations of this aspect of the disclosure may include one or more of the following optional features. In some implementations, determining the aggregate of the first DP model and the plurality of intermediate checkpoints includes determining aggregate parameter values based on parameter values of the first DP model and parameter values of the plurality of intermediate checkpoints, and determining, using the aggregate, the second DP model includes using the aggregate parameter values as parameter values of the second DP model. In some examples, determining the aggregate parameter values includes determining a weighted sum of the parameter values of the first DP model and the parameter values of the plurality of intermediate checkpoints.

In some examples, determining the aggregate parameter values includes selecting a subset of intermediate checkpoints from the plurality of intermediate checkpoints, and averaging the parameter values of the first DP model and the parameter values of the subset of intermediate checkpoints. In some implementations, the subset of intermediate checkpoints includes a threshold number of latest intermediate checkpoints. In some examples, selecting the subset of intermediate checkpoints from the plurality of intermediate checkpoints includes determining, for each respective intermediate checkpoint of the plurality of intermediate checkpoints, a respective quality factor, and selecting each intermediate checkpoint of the subset of intermediate checkpoints based on the respective quality factor.

In some implementations, determining the aggregate of the first DP model and the plurality of intermediate checkpoints includes determining a combination of the first DP model and the plurality of intermediate checkpoints, and the second DP model includes the determined combination. In some examples, determining the aggregate of the first DP model and the plurality of intermediate checkpoints includes selecting a subset of intermediate checkpoints from the plurality of intermediate checkpoints, and determining the combination to include the first DP model and the selected subset of the intermediate checkpoints. In some implementations, the subset of intermediate checkpoints includes a threshold number of latest intermediate checkpoints. In some examples, selecting the subset of intermediate checkpoints from the plurality of intermediate checkpoints includes determining, for each respective intermediate checkpoint of the plurality of intermediate checkpoints, a respective quality factor, and selecting each intermediate checkpoint of the subset of intermediate checkpoints based on the respective quality factor.

In some examples, the operations also include determining outputs of the first DP model, determining a plurality of outputs for respective ones of the plurality of intermediate checkpoints, and determining outputs of the second DP model includes an aggregate of the outputs of the first DP model and the plurality of outputs for respective ones of the plurality of intermediate checkpoints. In some implementation, the aggregate of the outputs of the first DP model and the plurality of outputs for respective ones of the plurality of intermediate checkpoints includes a majority vote based on the outputs of the first DP model and the plurality of outputs for respective ones of the plurality of intermediate checkpoints. In other implementations, the aggregate of the outputs of the first DP model and the plurality of outputs for respective ones of the plurality of intermediate checkpoints includes an average of the outputs of the first DP model and the plurality of outputs for respective ones of the plurality of intermediate checkpoints. The operations may include predicting, using the second DP model, an output, and determining, using at least one of the plurality of intermediate checkpoints, an uncertainty of the predicted output.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example machine learning system that leverages intermediate checkpoints to improve the performance of a trained differentially private (DP) model.

FIG. 2 illustrates a sequence of DP models generated by a DP training engine of FIG. 1.

FIG. 3A is a schematic view of an example of aggregating checkpoints.

FIG. 3B is a schematic view of another example of aggregating checkpoints.

FIG. 4 depicts an example set of checkpoints used to determine a confidence interval of a trained DP model.

FIG. 5 a flowchart of an example arrangement of operations for a computer-implemented method of leveraging intermediate checkpoints to improve the performance of a trained DP model.

FIG. 6 is a schematic view of an example computing device that may be used to implement the systems and methods described herein.

Like reference symbols in the various drawings indicate like elements.

### DETAILED DESCRIPTION

Differential privacy refers to a system for sharing information from a dataset without revealing information about individuals from the dataset. That is, a user who receives differentially private information from a dataset ideally cannot infer any information about a single individual of the dataset. This allows, for example, the publication of demographic information while ensuring the privacy of individuals who provide the information. Differentially private (DP) machine learning is commonly used for training private models on private data. A trained DP model is trained to not reveal sensitive information from the private data used to train the DP model. That is, an observer of a DP model cannot infer from the predictions of the DP model whether data of a particular entity was used to train the model. Differentially private stochastic gradient descent (DP-SGD) has become a de facto standard algorithm for centralized training of DP models.

Implementations herein include a machine learning system for training and improving DP models. The system leverages intermediate checkpoints generated during training the model to improve the model without impacting the privacy provided by the model. For example, the system aggregates parameters and/or outputs of intermediate checkpoints to update or fine-tune the final model, resulting in an updated model with improved prediction accuracy and lower bounded confidence intervals.

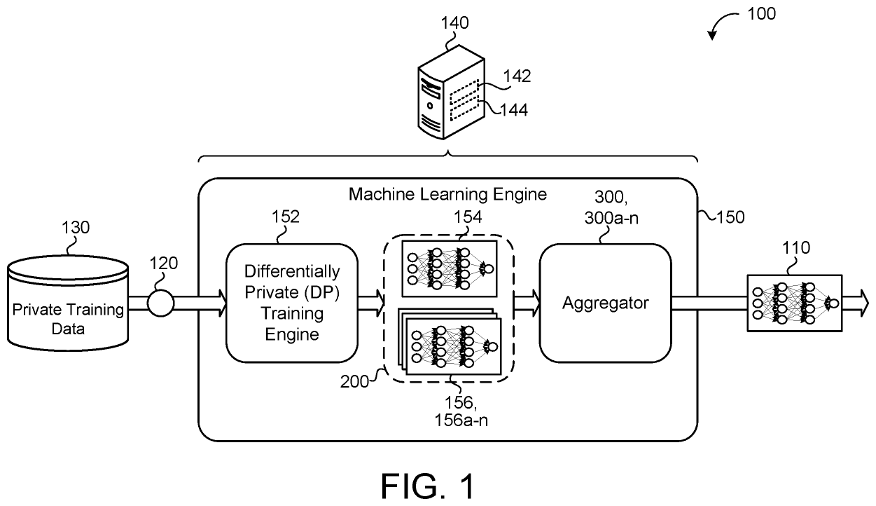

FIG. 1 is a schematic view of an example machine learning system 100 for training, using machine learning, a DP machine learning model 110 based on a private training set 120 of private data taken from a datastore 130, among possibly other data, such as public data (not shown for clarity of illustrations). The machine learning system 100 trains the DP model 110 such that the machine learning system 100 can guarantee the differential privacy of the DP model 110. In some examples, a guarantee of differential privacy for the DP model 110 indicates that an adversary cannot infer from the DP model 110 (e.g., based on its parameters), or outputs thereof, whether the DP model 110 was trained on particular private data of the private training set 120, or particular private or sensitive information associated with any data of the private training set 120.

The machine learning system 100 includes a computing system 140 for performing DP machine learning, among possibly other functions. In some examples, the computing system 140 includes a central server configured to train the DP model 110 for use by the computing system 140 to make inferences based on local or received input data. For example, input data is received from one or more client or user devices (not shown for clarity of illustrations) and the central server makes inferences, using the trained DP model 110, based on the received input data on behalf of the one or more client or user devices. Additionally or alternatively, the computing system 140 is configured to train the DP model 110 for use by one or more client or user devices, such that the one or more client or user devices use the DP model 110 to make local or private inferences based on local or private input data. In some implementations, the computing system 140 includes a central server configured to train the DP model 110 using federated learning based on prediction losses (e.g., gradients) determined by one or more client or user devices and provided to the central server for use in training the DP model 110. Here, the client or user devices may determine the prediction losses such that private or sensitive information is not exposed to the central server.

The computing system 140 may correspond to any computing device capable of receiving inputs, processing, and providing outputs. The computing system 140 includes data processing hardware 142, and memory hardware 144 in communication with the data processing hardware 142. The memory hardware 144 stores instructions that, when executed by the data processing hardware 142, cause the data processing hardware 142 or, more generally, the computing system 140 to perform one or more operations including, without limitation, perform DP machine learning training of the DP model 110. In some examples, the memory hardware 144 stores the datastore 130. In the example shown, the computing system 140 is a single computing system. However, the computing system 140 may be implemented by one or more computing systems, one or more cloud-based computing systems, and/or one or more virtualized computing environments.

The computing system 140 may include, or may be coupled to, one or more input systems (not shown for clarity of illustration) to capture, record, receive, or otherwise obtain input data, among possibly other inputs. The input system(s) may be used to obtain inputs from users, other devices, other systems, etc. The computing system 140 may also include, or be coupled to, one or more output systems (not shown for clarity of illustration) to output or otherwise provide prediction outputs (e.g., inferences based on input data), among possibly other outputs. The output system(s) may be used to provide outputs to users, devices, other systems, etc. The computing system 140 may also include one or more communication interfaces and/or transceivers (not shown for clarity of illustration) to receive inputs from, or provide outputs to, users, other devices, other systems, etc. via one or more communication networks (not shown for clarity of illustration). For example, via any combination of local area networks (LANs), wide area networks (WANs), wired networks, wireless networks, cellular networks, and/or any other types of networks.

The computing system 140 implements a machine learning engine 150 configured for training the DP model 110 using DP machine learning based on the private training set 120 of private data (e.g., demographic data, medical data, and any other sensitive or confidential data) taken from the datastore 130, among possibly other data, such as public data. The machine learning engine 150 trains the DP model 110 such that the machine learning system 100 can guarantee the differential privacy of the DP model 110. In some examples, the machine learning engine 150 is a software application executed by the computing system 140. A software application (i.e., a software resource) may refer to computer software (i.e., instructions) that, when executed by a computing device (e.g., the computing system 140), causes the computing device to perform one or more operations corresponding to a task. In some examples, a software application is referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The machine learning engine 150 implements a DP training engine 152 configured for performing DP machine learning of a DP model 154 based on training samples of the private training set 120, among possibly other data, such as public data. The DP training engine 152 generates, using DP machine learning based on the training samples, a sequence of DP models 200 that includes the DP model 154 as a current DP model and one or more preceding intermediate DP models 156. Here, the DP model 154 represents a current checkpoint, and each of the intermediate DP models 156 represents an intermediary checkpoint of the training of the DP model 154 by the DP training engine 152. Each intermediary checkpoint represents a respective different intermediate state of the trained DP model 154 (i.e., each includes different weights). Accordingly, the DP models 154, 156 are also referred to herein as checkpoints 154, 156.

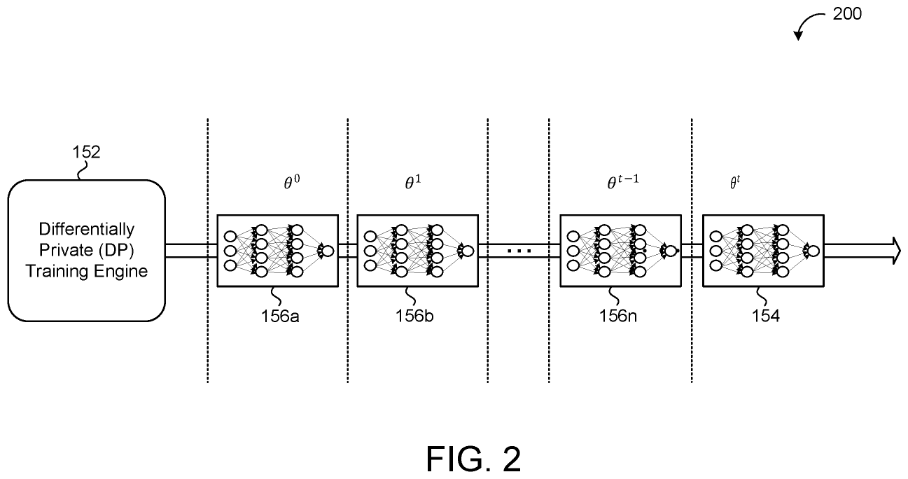

FIG. 2 depicts an example of the sequence of DP models 200 generated by the DP training engine 152 of FIG. 1. The DP model 200 includes the DP model 154 as checkpoint θ^{t} generated by the DP training engine 152 at current time step t, a previous DP model 156n as checkpoint θ^{t-1} generated by the DP training engine 152 at time step t−1, . . . , and a previous DP model 156a as checkpoint θ⁰ generated by the DP training engine 152 at time step 0.

Referring back to FIG. 1, the DP training engine 152 generates the DP models 154, 156 using any number and/or type(s) of DP machine learning algorithm(s) and/or method(s). For example, the DP training engine 152 uses differentially private stochastic gradient descent (DP-SGD) for centralized learning, or differential private follow-the-regularized leader (DP-FTRL) for federated learning. The DP training engine 152 trains the DP models 154, 156 such that the DP training engine 152 can guarantee the differential privacy of each of the DP models 154, 156, taken individually or in combinations thereof. For example, an adversary cannot infer from any of the DP models 154, 156 (e.g., based on its parameters), alone or in combination, or outputs thereof, whether the DP models 154, 156 were trained on particular private data of the private training set 120, or particular private information associated with any data of the private training set 120. In some examples, the DP training engine 152 trains the DP models 154, 156 using supervised learning based on paired private training data. However, unsupervised learning may, alternatively or additionally, be used.

The DP training engine 152 trains the DP models 154, 156 according to a differential privacy budget that defines a maximum acceptable amount of information about individual training samples of the private training set 120 that may be revealed or leaked by the trained DP models 154, 156. An example differential privacy guarantee (i.e., a differential privacy budget) is defined by three hyper-parameters of, for example, the DP-SGP algorithm: (i) a standard deviation of DP noise, (ii) a sampling ratio, and (iii) a number of training steps or rounds. To ensure the differential privacy of the DP models 154, 156 satisfies the differential privacy budget, the DP training engine 152 implements a privacy calibration process that is performed using a privacy accountant. An example privacy accountant is a numerical algorithm that provides a tight upper bound for the differential privacy budget as a function of selected hyper-parameters, and utilizes a composition analysis across training steps/rounds such that the DP training engine 152 can guarantee that each of the DP models 154, 156 satisfies the differential privacy budget.

Conventionally, the current or final DP model 154 is used as the DP model 110 during inference to make predictions based on input data. However, recognizing that DP training algorithms, such as DP-SGD and DP-FTRL, are randomized algorithms (e.g., that their outcomes depend on the randomness in their parameters), the machine learning engine 150 implements a checkpoint aggregator 300 that is configured to combine and/or aggregate aspects of the DP models 154, 156 (i.e., checkpoints 154, 156 {θ^{t}, θ^{t-1} . . . , θ¹, θ⁰}) to reduce the effect of such randomness on the accuracy and/or the variance of the DP model 110. The checkpoint aggregator 300 determines an aggregate of the checkpoints 154, 156, and uses the aggregate to generate the DP model 110. It has been advantageously discovered that using an aggregate of aspects of the checkpoints 154, 156 during inference can improve the accuracy of predictions made by the DP model 110 while guaranteeing that the DP model 110 satisfies the same differential privacy budget used by the DP training engine 152 when generating the checkpoints 154, 156. That is, the checkpoint aggregator 300 can improve the accuracy of the DP model 110, as compared to the DP model 154, while ensuring the DP model 110 satisfies the differential privacy guarantee.

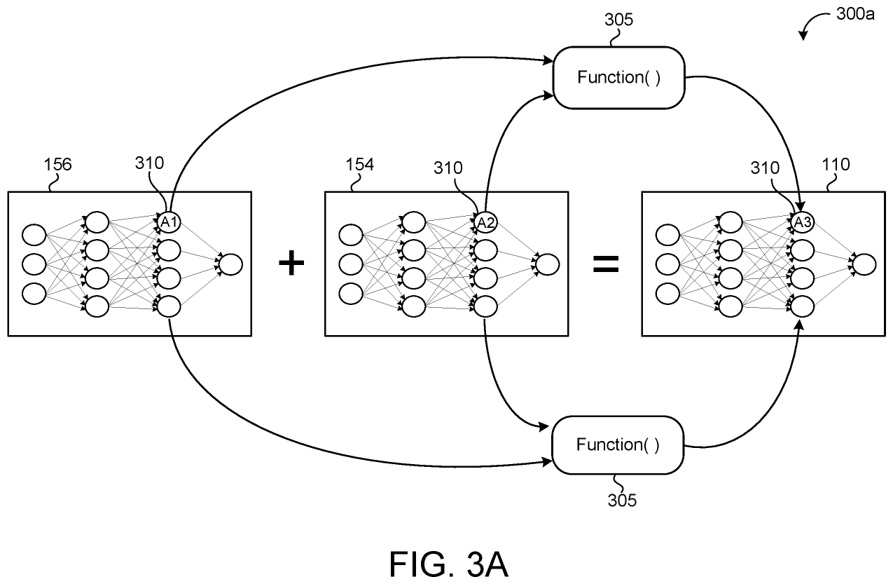

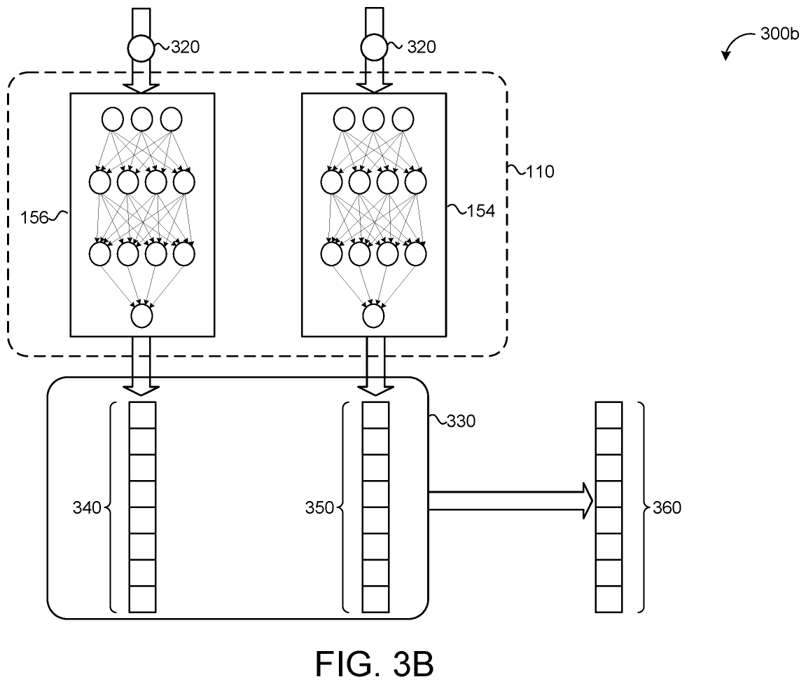

FIG. 3A is a schematic view of an example checkpoint aggregator 300a for the machine learning engine 150 of FIG. 1 that determines, during training, aggregates of the parameters of at least a subset of the checkpoints 154, 156 to determine parameters of the DP model 110. In some examples, the checkpoint aggregator 300a: (i) computes, for each particular parameter of the subset of the checkpoints 154, 156, an aggregate parameter value by applying a function to the values of the particular parameter for each of the subset of the checkpoints 154, 156 (i.e., the DP model 154 and the intermediate checkpoints 156), (ii) uses the aggregate parameter value for the particular parameter for the DP model 110, and (iii) uses the DP model 110 with the aggregate parameter value to determine outputs of the DP model 110 during inference. For example, the checkpoint aggregator 300a applies a function 305 to the value A1 of a particular parameter 310 of an intermediate checkpoint 156 and the value A2 of the same particular parameter 310 of the DP model 154 (i.e., checkpoint 154) to generate an aggregate parameter value A3 for the same particular parameter 310 of the DP model 110.

In some examples, the checkpoint aggregator 300a computes aggregate parameter values for the DP model 110 using an exponential moving average (EMA). Here, starting from the last and most recent checkpoint θ^{t} (i.e., the DP model 154), the checkpoint aggregator 300a assigns exponentially decaying weights to each previous checkpoint θ^{t-i} (i.e., the DP models 156a-n) as shown in Equation (2), where the weights are a function of a decay parameter β.

$${θ}_{ema}^{t} = ( 1 - β ) \cdot {θ}_{ema}^{t - 1} + β \cdot {θ}^{t} \qquad ( 1 )$$

$$= {\sum }_{i = 2}^{t} {( 1 - β )}^{t - i} \cdot β \cdot {θ}^{i} + {( 1 - β )}^{t - 1} \cdot {θ}^{1} \qquad ( 2 )$$

$${θ}_{upa}^{t , k} = \frac{1}{k} {\sum }_{i = t - ( k - 1 )}^{t} {θ}^{i} \qquad ( 3 )$$

In some examples, during training and at each step t, the checkpoint aggregator 300a updates a running moving average θₑₘₐ^{t} of all the checkpoints thus far by computing a weighted average of the moving average θₑₘₐ^{t} of all the previous checkpoints until step t−1 and the t^{th} checkpoint θ^{t}, as expressed in Equation (1). Because EMA assigns larger weights to the aggregates of prior checkpoints 156, which may be counterproductive at the beginning of training when past checkpoints 156 may have lower accuracy, the checkpoint aggregator 300a may adapt the value of the decay parameter β^{t} at time step t to be equal to

$$min ( β , \frac{1 + t}{10 + t} ) .$$

Alternatively, the checkpoint aggregator 300a computes aggregate parameter values for the DP model 110 using a uniformly weighted average (UWA) of a recent subset of k checkpoints 154, 156. Here, starting from the last, most recent checkpoint θ^{t} (i.e., the DP model 154), the checkpoint aggregator 300a assigns uniform weights

$$\frac{1}{k}$$

to the checkpoint 154 and each of the k−1 previous checkpoints 156, as shown in Equation (3).

The checkpoint aggregator 300a may select the subset of checkpoints 154, 156 used to compute aggregate parameter values (e.g., using EMA or UWA) for the DP model 110 to include, for example, a recent subset of the checkpoints 154, 156, at least a threshold number of recent checkpoints 154, 156, every other checkpoint 154, 156, all of the checkpoints 154, 156, etc. Alternatively, the checkpoint aggregator 300a selects the subset by determining a quality factor for each of the checkpoints 154, 156 and selecting the subset based on the quality factors. For example, the checkpoint aggregator 300a determines prediction performances of the checkpoints 154, 156 when applied to, for example, non-private, held-out data (i.e., not used during training), and selecting the best performing checkpoints 154, 156 as the subset.

FIG. 3B is a schematic view of another example checkpoint aggregator 300b for the machine learning engine 150 of FIG. 1 that enables the DP model 110 to include an aggregate of the checkpoints 154, 156. For example, the aggregate of the checkpoints 154, 156 includes a combination of the checkpoints 154, 156. Accordingly, during inference, the DP model 110 computes outputs of at least a subset of the checkpoints 154, 156 responsive to the same input data 320, and uses an aggregate of the outputs as the output of the DP model 110. For example, the checkpoint aggregator 300b applies a function 330 to the output values 340 of a checkpoint 156 and the output values 350 of the checkpoint 154 to generate an aggregate output 360 used as the output of the DP model 110. Put another way, while the example checkpoint aggregator 300a of FIG. 3A aggregates the parameters of the checkpoints 154, 156, the example checkpoint aggregator 300b aggregates the outputs of the checkpoints 154, 156.

In some examples, for a given input x 320, the checkpoint aggregator 300b uses output prediction vector averaging (OPA) to determine the output of the DP model 110. For example, by computing output prediction vectors ƒ_{θ}_{ⁱ}(x) for each of k past checkpoints (i.e., from steps ∈[t−(k−1), t]. The checkpoint aggregator 300b then (i) computes an average of the output prediction vectors ƒ_{θ}_{ⁱ}(x), (ii) computes argmax( ) of the average as an aggregate output ŷₒₚₐ(x), as shown in Equation (4), and then (iii) uses the aggregate output ŷₒₚₐ(x) as the output of the DP model 110.

$${\hat{y}}_{opa} ( x ) = arg max ( \frac{1}{k} {\sum }_{i = t - ( k - 1 )}^{t} {f}_{{θ}^{i}} ( x ) ) \qquad ( 4 )$$

$${\hat{y}}_{omv} ( x ) = {Majority ( arg max ( {f}_{{θ}^{i}} ( x ) ) )}_{i = t - ( k - 1 )}^{t} \qquad ( 5 )$$

Alternatively, for a given input x 320, the checkpoint aggregator 300b uses output labels majority vote (OMV) to determine the output of the DP model 110. For example, by computing output prediction vectors ƒ_{θ}_{ⁱ}(x) for each of k past checkpoints and corresponding labels using, for example, argmax (ƒ_{θ}_{ⁱ}(x)). The checkpoint aggregator 300b then uses the majority label among the k labels of the k checkpoints as its final aggregate output ŷₒₘᵥ(x), as shown in Equation (5), and uses the aggregate output ŷₒₘᵥ(x) as the output of the DP model 110.

The checkpoint aggregator 300b may select the subset of checkpoints 154, 156 used to compute an aggregate output (e.g., using OPA or OMV) for the DP model 110 to include, for example, a recent subset of the checkpoints 154, 156, at least a threshold number of recent checkpoints 154, 156, every other checkpoint 154, 156, all of the checkpoints 154, 156, etc. Alternatively, the checkpoint aggregator 300b selects the subset by determining a quality factor for each of the checkpoints 154, 156 and selecting the subset based on the quality factors. For example, the checkpoint aggregator 300b determines prediction performances of the checkpoints 154, 156 when applied to, for example, non-private, held-out data (i.e., not used during training), and selecting the best performing checkpoints 154, 156 as the subset.

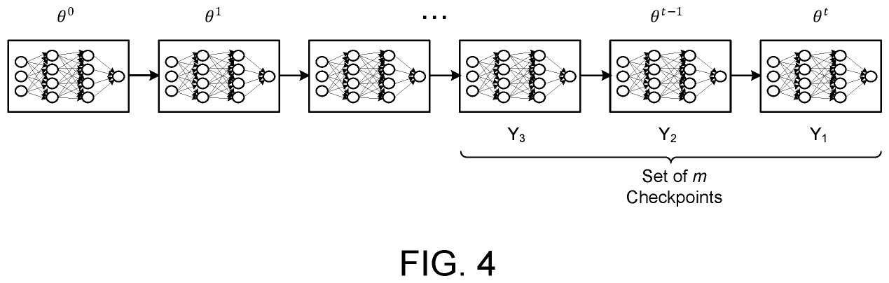

Referring back to FIG. 1, DP machine language training is deterministic when all hyper-parameters are held constant. However, the DP noise of DP machine language is inherently random and, thus, adds uncertainty to the resulting DP model. Conventionally, a confidence interval for a DP model is determined using brute force based on a plurality of trainings of the DP model resulting from a plurality of different training runs for the DP model. However, such a brute force method is computationally expensive, impossible with federated learning, and compromises differential privacy. However, recognizing that DP training algorithms, such as DP-SGD and DP-FTRL, are randomized algorithms (e.g., that their outcomes depend on the randomness in their parameters, such as DP noise), the checkpoint aggregator 300 may determine a lower bound on the confidence interval for the DP model 110 using a set of m of the checkpoints 154, 156 (e.g., checkpoints Y₁, Y₂, and Y₃ as shown in FIG. 4) as proxies for m independent trainings of the DP model 110. Such a lower bound of the confidence interval may be computed with substantially fewer computations, is compatible with federated learning, and does not compromise differential privacy.

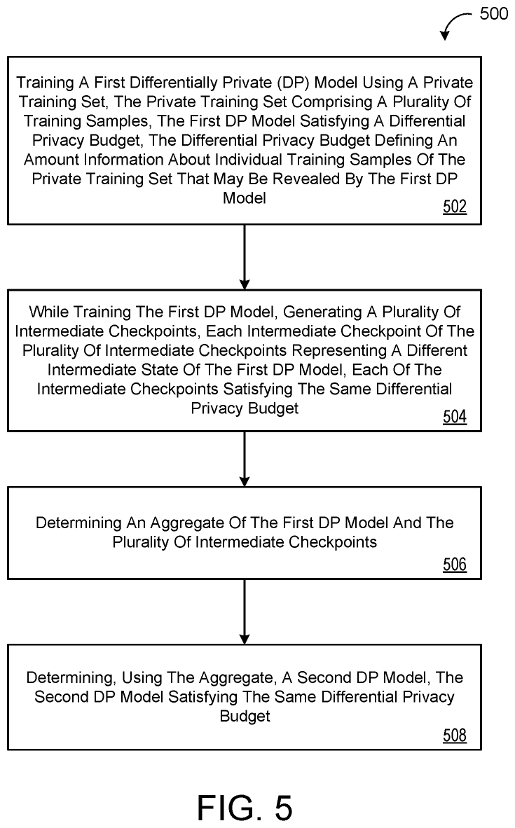

FIG. 5 is a flowchart of an exemplary arrangement of operations for a computer-implemented method 500 for using intermediate checkpoints to improve the performance of a trained DP model, such as the DP model 110. At operation 502, the method 500 includes training a first differentially private (DP) model (e.g., the DP model 154) using a private training set 120. Here, the private training set 120 includes a plurality of training samples, and the first DP model 154 satisfies a differential privacy budget, and the differential privacy budget defines an amount information about individual training samples of the private training set 120 that may be revealed by the first DP model 154. While training the first DP model 154, the method 500 at operation 504 includes generating a plurality of intermediate checkpoints (e.g., the checkpoints 156). Here, each intermediate checkpoint 156 of the plurality of intermediate checkpoints 156 represents a different intermediate state of the first DP model 154, and each of the intermediate checkpoints 156 satisfy the same differential privacy budget.

At operation 506, the method 500 includes determining an aggregate of the DP model 154 and the plurality of intermediate checkpoints 156. For example, aggregate parameters values, or aggregates of outputs. At operation 508, the method 500 includes determining, using the aggregate, a second DP model, the second DP model satisfying the same differential privacy budget.

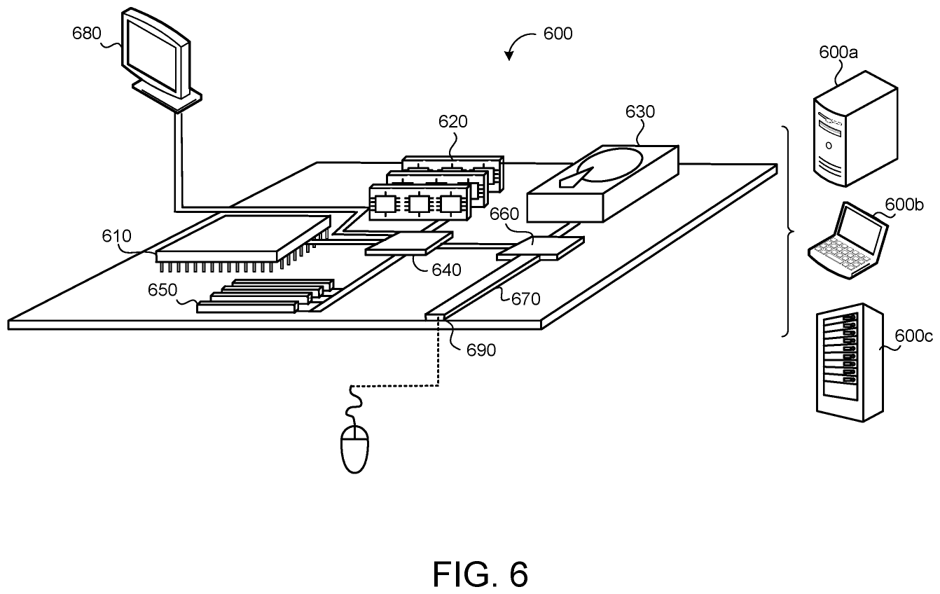

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610 (i.e., data processing hardware) that may be used to implement the data processing hardware 142, memory 620 (i.e., memory hardware) that can be used to implement the memory hardware 144 and the datastore 130, a storage device 630 (i.e., memory hardware) that can be used to implement the memory hardware 144 and the datastore 130, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, “or” refers to an inclusive or and not to an exclusive or. For example, “A, B, or C” refers to any combination or subset of A, B, C such as: (1) A alone; (2) B alone; (3) C alone; (4) A with B; (5) A with C; (6) B with C; and (7) A with B and with C. Similarly, the phrase “at least one of A or B” is intended to refer to any combination or subset of A and B such as: (1) at least one A; (2) at least one B; and (3) at least one A and at least one B. Moreover, the phrase “at least one of A and B” is intended to refer to any combination or subset of A and B such as: (1) at least one A; (2) at least one B; and (3) at least one A and at least one B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
training a first differentially private (DP) model using a private training set, the private training set comprising a plurality of training samples, the first DP model satisfying a differential privacy budget, the differential privacy budget defining an amount of information about individual training samples of the private training set that may be revealed by the first DP model;
while training the first DP model, generating a plurality of intermediate checkpoints, each intermediate checkpoint of the plurality of intermediate checkpoints representing a different intermediate state of the first DP model, each of the intermediate checkpoints satisfying the same differential privacy budget;
determining an aggregate of the first DP model and the plurality of intermediate checkpoints; and
determining, using the aggregate, a second DP model, the second DP model satisfying the same differential privacy budget.

2. The computer-implemented method of claim 1, wherein:
determining the aggregate of the first DP model and the plurality of intermediate checkpoints comprises determining aggregate parameter values based on parameter values of the first DP model and parameter values of the plurality of intermediate checkpoints; and
determining, using the aggregate, the second DP model comprises using the aggregate parameter values as parameter values of the second DP model.

3. The computer-implemented method of claim 2, wherein determining the aggregate parameter values comprises determining a weighted sum of the parameter values of the first DP model and the parameter values of the plurality of intermediate checkpoints.

4. The computer-implemented method of claim 2, wherein determining the aggregate parameter values comprises:
selecting a subset of intermediate checkpoints from the plurality of intermediate checkpoints; and
averaging the parameter values of the first DP model and the parameter values of the subset of intermediate checkpoints.

5. The computer-implemented method of claim 4, wherein the subset of intermediate checkpoints comprises a threshold number of latest intermediate checkpoints.

6. The computer-implemented method of claim 4, wherein selecting the subset of intermediate checkpoints from the plurality of intermediate checkpoints comprises:
determining, for each respective intermediate checkpoint of the plurality of intermediate checkpoints, a respective quality factor; and
selecting each intermediate checkpoint of the subset of intermediate checkpoints based on the respective quality factor.

7. The computer-implemented method of claim 1, wherein:
determining the aggregate of the first DP model and the plurality of intermediate checkpoints comprises determining a combination of the first DP model and the plurality of intermediate checkpoints; and
the second DP model comprises the determined combination.

8. The computer-implemented method of claim 7, wherein determining the aggregate of the first DP model and the plurality of intermediate checkpoints comprises:
selecting a subset of intermediate checkpoints from the plurality of intermediate checkpoints; and
determining the combination to include the first DP model and the selected subset of the intermediate checkpoints.

9. The computer-implemented method of claim 8, wherein the subset of intermediate checkpoints comprises a threshold number of latest intermediate checkpoints.

10. The computer-implemented method of claim 8, wherein selecting the subset of intermediate checkpoints from the plurality of intermediate checkpoints comprises:
determining, for each respective intermediate checkpoint of the plurality of intermediate checkpoints, a respective quality factor; and
selecting each intermediate checkpoint of the subset of intermediate checkpoints based on the respective quality factor.

11. The computer-implemented method of claim 7, wherein the operations further comprise:
determining outputs of the first DP model;
determining a plurality of outputs for respective ones of the plurality of intermediate checkpoints; and
determining outputs of the second DP model comprising an aggregate of the outputs of the first DP model and the plurality of outputs for respective ones of the plurality of intermediate checkpoints.

12. The computer-implemented method of claim 11, wherein the aggregate of the outputs of the first DP model and the plurality of outputs for respective ones of the plurality of intermediate checkpoints comprises a majority vote based on the outputs of the first DP model and the plurality of outputs for respective ones of the plurality of intermediate checkpoints.

13. The computer-implemented method of claim 11, wherein the aggregate of the outputs of the first DP model and the plurality of outputs for respective ones of the plurality of intermediate checkpoints comprises an average of the outputs of the first DP model and the plurality of outputs for respective ones of the plurality of intermediate checkpoints.

14. The computer-implemented method of claim 1, wherein the operations further comprise:
predicting, using the second DP model, an output; and
determining, using at least one of the plurality of intermediate checkpoints, an uncertainty of the predicted output.

15. A system comprising:
data processing hardware; and
memory hardware in communication with the data processing hardware, the memory hardware storing instructions that when executed on the data processing hardware cause the data processing hardware to perform operations comprising:
training a first differentially private (DP) model using a private training set, the private training set comprising a plurality of training samples, the first DP model satisfying a differential privacy budget, the differential privacy budget defining an amount of information about individual training samples of the private training set that may be revealed by the first DP model;
while training the first DP model, generating a plurality of intermediate checkpoints, each intermediate checkpoint of the plurality of intermediate checkpoints representing a different intermediate state of the first DP model, each of the intermediate checkpoints satisfying the same differential privacy budget;
determining an aggregate of the first DP model and the plurality of intermediate checkpoints; and
determining, using the aggregate, a second DP model, the second DP model satisfying the same differential privacy budget.

16. The system of claim 15, wherein:
determining the aggregate of the first DP model and the plurality of intermediate checkpoints comprises determining aggregate parameter values based on parameter values of the first DP model and parameter values of the plurality of intermediate checkpoints; and
determining, using the aggregate, the second DP model comprises using the aggregate parameter values as parameter values of the second DP model.

17. The system of claim 16, wherein determining the aggregate parameter values comprises determining a weighted sum of the parameter values of the first DP model and the parameter values of the plurality of intermediate checkpoints.

18. The system of claim 16, wherein determining the aggregate parameter values comprises:
selecting a subset of intermediate checkpoints from the plurality of intermediate checkpoints; and
averaging the parameter values of the first DP model and the parameter values of the subset of intermediate checkpoints.

19. The system of claim 18, wherein the subset of intermediate checkpoints comprises a threshold number of latest intermediate checkpoints.

20. The system of claim 18, wherein selecting the subset of intermediate checkpoints from the plurality of intermediate checkpoints comprises:
determining, for each respective intermediate checkpoint of the plurality of intermediate checkpoints, a respective quality factor; and
selecting each intermediate checkpoint of the subset of intermediate checkpoints based on the respective quality factor.

21. The system of claim 15, wherein:
determining the aggregate of the first DP model and the plurality of intermediate checkpoints comprises determining a combination of the first DP model and the plurality of intermediate checkpoints; and
the second DP model comprises the determined combination.

22. The system of claim 21, wherein determining the aggregate of the first DP model and the plurality of intermediate checkpoints comprises:
selecting a subset of intermediate checkpoints from the plurality of intermediate checkpoints; and
determining the combination to include the first DP model and the selected subset of the intermediate checkpoints.

23. The system of claim 22, wherein the subset of intermediate checkpoints comprises a threshold number of latest intermediate checkpoints.

24. The system of claim 22, wherein selecting the subset of intermediate checkpoints from the plurality of intermediate checkpoints comprises:
determining, for each respective intermediate checkpoint of the plurality of intermediate checkpoints, a respective quality factor; and
selecting each intermediate checkpoint of the subset of intermediate checkpoints based on the respective quality factor.

25. The system of claim 15, wherein the operations further comprise:
determining outputs of the first DP model;
determining a plurality of outputs for respective ones of the plurality of intermediate checkpoints; and
determining outputs of the second DP model comprising an aggregate of the outputs of the first DP model and the plurality of outputs for respective ones of the plurality of intermediate checkpoints.

26. The system of claim 25, wherein the aggregate of the outputs of the first DP model and the plurality of outputs for respective ones of the plurality of intermediate checkpoints comprises a majority vote based on the outputs of the first DP model and the plurality of outputs for respective ones of the plurality of intermediate checkpoints.

27. The system of claim 25, wherein the aggregate of the outputs of the first DP model and the plurality of outputs for respective ones of the plurality of intermediate checkpoints comprises an average of the outputs of the first DP model and the plurality of outputs for respective ones of the plurality of intermediate checkpoints.

28. The system of claim 15, wherein the operations further comprise:
predicting, using the second DP model, an output; and
determining, using at least one of the plurality of intermediate checkpoints, an uncertainty of the predicted output.
